(19) United States
(12) Patent Application Publication
(10) Pub. No.: US 2002/0061217 A1
(43) Pub. Date: May 23, 2002

(54) Electronic input device

(76) Inventors: Robert Hillman, San Diego, CA (US); Chirag D. Patel, Huntsville, AL (US); Philip Layton, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/823,957

(22) Filed: Mar. 30, 2001

Related U.S. Application Data
(60) Provisional application No. 60/249,876, filed on Nov. 17, 2000.

(51) Int. Cl. B41J 5/10

(52) U.S. Cl. 400/489; 400/472

(57) ABSTRACT

A device and a method are disclosed for creating a virtual keyboard, mouse, or position detector. The device is an electronic keyboard that detects the position of a user's finger. The position of a user's fingers are detected by sending out a light beam parallel to the surface of, for example, a desk, and then detecting the position of a user's finger as the light beam is blocked by the finger. The position and movement of the user's fingers determine which key is to be struck or in which direction to move the pointer.

### BACKGROUND OF THE INVENTION

1. Field of the Invention

The invention relates to an apparatus and method for allowing a user to configure and use an electronic input device. More specifically this invention relates to an apparatus and method for allowing a user to input data into an electronic device by the use of a flexible reconfigurable keyboard.

2. Description of the Related Art

Conventional personal computer systems and other electronic devices rely on keyboards as their main source of data input. Unfortunately, keyboards are typically large, unwieldy devices that are difficult to transport. This is not a problem for desktop computers, but as new miniaturized electronic devices such as personal digital assistants, wireless phones, two-way pagers, laptop computers and the like become more widely used, the size of the keyboard becomes increasingly important. For this reason, many others have attempted to design devices that act like keyboards, but do not have the size and weight of conventional keyboards.

For example, touch screen systems and optical touch panels have been used to allow a computer screen to act as a keyboard for data entry. In these touch screens an optical assembly generates a series of light beams, which criss-cross the surface of a computer screen. If no objects block the path of the light beam, the light travels to a detector, producing a continuous photocurrent. If an object such as a user's finger blocks the beam, then there is a discontinuous photo-detector current, indicating that the user had touched the screen. Triangulation algorithms or similar techniques allow for the calculation of the position of the user's finger on the screen. Examples of this methodology are set forth in U.S. Pat. No. 3,553,680 (Cooreman), U.S. Pat. No. 3,613,066 (Cooreman et al), U.S. Pat. No. 3,898,445 (Macleod), U.S. Pat. No. 4,294,543 (Apple et al), U.S. Pat. No. 4,125,261 (Barlow et al), U.S. Pat. No. 4,558,313 (Garwin et al), U.S. Pat. No. 4,710,759 (Fitzgibbon et al), U.S. Pat. No. 4,710,758 (Mussler et al) and U.S. Pat. No. 5,196,835 (Blue et al). These systems, however, have problems with reliability and require a video display terminal (VDT) which are inconvenient for small handheld devices. In addition, touch screens require part of the VDT to be used to display the keyboard or required input keys.

In addition to the touch screen technology, there are various other systems that have been described for detecting the position of a person's finger in order to enter data into a computer. One such system is described in U.S. Pat. No. 5,605,406 to Bowen wherein multiple detectors and receivers are placed across each row and column of a keyboard. These detectors are used to determine the exact position of a user's finger as the keys are pressed. Unfortunately, this system requires multiple transmitters and receivers, and are restricted to keyboards having a preset number of rows and columns.

Thus, what is needed in the art is a keyboard that can be reconfigured quickly and inexpensively to work with many different key patterns, and the ability to be transported easily with its associated electronic device.

### SUMMARY OF THE INVENTION

Embodiments of the invention relate to a virtual keyboard that is used to input data into electronic devices. The virtual keyboard provides electronics that emit a signal and then detect the position of an object, such as a user's finger, from the reflection of the emitted signal. By determining the position of the user's finger, the virtual keyboard correlates this position with a predefined keyboard map in its memory to determine which key was intended to be pressed by the user. The intended keystroke command is then electronically transferred to the electronic device as if it came from a conventional keyboard.

The virtual keyboard is particularly adaptable for computers, handheld devices, mobile phones, internet appliances, computer games, music keyboards, ruggedized industrial computers, touch screens and reconfigurable control panels. The user's finger positions in one embodiment are determined by generating a plane of light, or other electromagnetic source or sound wave. As the user's finger interrupts the plane of light, a reflected light pattern is detected by a detector in the virtual keyboard. The detector can be, for example, a charged couple device (CCD), a complementary metal oxide semiconductor (CMOS) image sensor or other appropriate detection device for detecting light. The position of the reflected light on the detector plane determines the user's finger position on the virtual keyboard. The keyboard is “virtual” because it is only the position of the user's finger as it breaks the light plane which determines which key has been pressed. Of course, in use the user will typically place a template below the light plane to act as a guide for the key positions.

Because embodiments of the invention detect the position of an object (such as a finger), the actual definition of the keys can be configured in software and the template of the keyboard can be printed out separately on a medium including, but not limited to, paper, metal or plastic, allowing for a rugged, reconfigurable input system for any type of electronic device.

Another application of the virtual keyboard described herein allows a conventional computer display, such as an LCD display to be outfitted as a touch screen. This is accomplished by placing the virtual keyboard system so that the position of a user's finger is detected as it touches the display screen. As the user touches the display screen, the virtual keyboard determines the position of the user's finger on the display. Instructions are then run to correlate the position of the user's finger on the display screen with the displayed item on the screen that was selected by the user. This acts like a conventional touch screen system, however provides a simple mechanism for retrofitting current computer displays with a simple add-on device.

### BRIEF DESCRIPTION OF THE DRAWINGS

These and other features will now be described in detail with reference to the drawings of preferred embodiments of the invention, which are intended to illustrate, and not limit, the scope of the invention.

FIG. 1 is a perspective view of a computing device connected to a reconfigurable virtual keyboard.

FIG. 2 is an illustration of one embodiment of a user defined configuration pattern for a virtual keyboard template.

FIG. 3 is a block diagram of one embodiment of virtual keyboard components.

FIG. 4 is a block diagram illustrating a side view of one embodiment of a virtual keyboard, FIG. 5 is a block diagram illustrating a top view of one embodiment of a virtual keyboard, first seen in FIG. 1.

FIG. 6 is an illustration of one embodiment of a two-dimensional pattern of light received by a virtual keyboard.

FIG. 7 is a high-level process flow diagram showing one embodiment of a process for determining the position of reflected light by a virtual keyboard.

FIG. 8 is a flow diagram showing one embodiment of a process for calibrating a reconfigurable virtual keyboard.

FIG. 9 is a flow diagram showing one embodiment of a process of detecting keystrokes on a reconfigurable virtual keyboard.

### DETAILED DESCRIPTION

The following detailed description is directed to specific embodiments of the invention. However, the invention can be embodied in a multitude of different ways as defined and covered by the claims. In this description, reference is made to the drawings wherein like parts are designated with the like numerals throughout.

Embodiments of the invention relate to a device and a method for creating a virtual keyboard, mouse, or position detector. One embodiment is a reconfigurable virtual keyboard that detects the position of a user's fingers to determine which keys have been pressed. The position and movement of the user's fingers determine which key was intended to be struck. The position of the user's fingers is detected by emitting a light beam, or other electromagnetic wave, parallel to the surface of, for example, a desk. The position of the user's finger is then detected as the light beam is reflected back to the detector by the user's finger.

The device is reconfigurable in that the actual layout of a keyboard is stored in a memory of the device, and thus can be changed at any time. For example, a first user might choose to enter data using an 84 key keyboard layout, whereas a second user may choose to enter data using a 101 key keyboard. Accordingly, each user could choose from a selection menu the type of keyboard they prefer. Other types of keyboards having different keyboard layouts could also be chosen from the memory.

In addition, the device is reconfigurable in that it can detect actual motion by the user's fingers. For example, in one embodiment, the device is configured to detect the motion of a user's finger within a predefined area, such as a square. This area acts as a mouse region, wherein movement of the user's finger within the region is translated into mouse movements on a linked display. This is useful for providing mouse capabilities to devices such as personal computers, Personal Digital Assistants (PDAs) and the like.

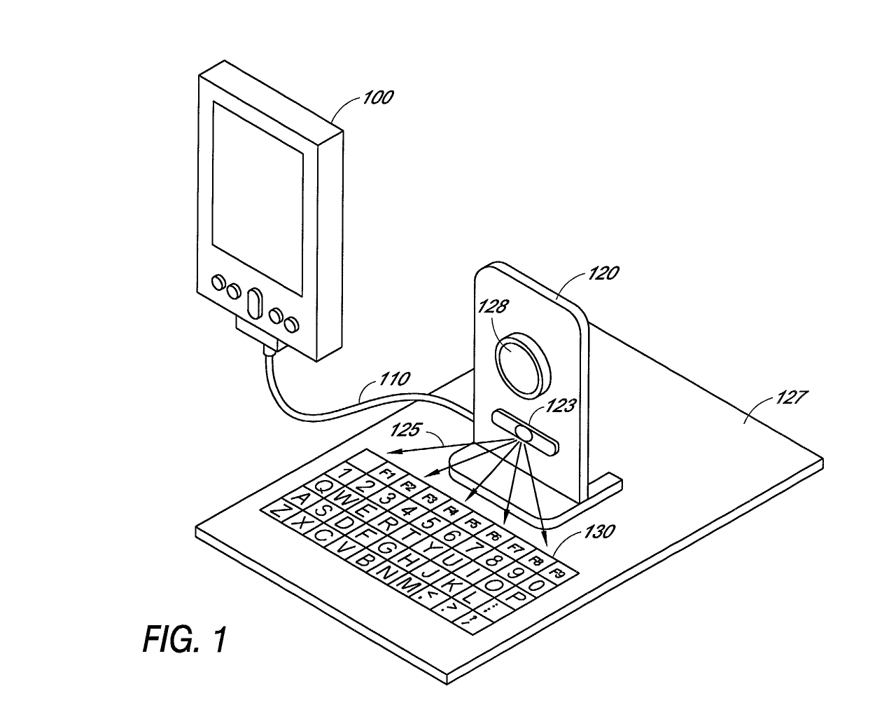

FIG. 1 is an illustration that shows one embodiment of a virtual keyboard 120 interacting with a computing device 100. In one embodiment, the stand-alone device 100 is a PDA, such as a Palm Pilot (Palm, Inc.) or other handheld electronic organizer. The stand-alone device 100 may have any number of hardware components including a processor used for performing tasks and fulfilling users requests, RAM to store users preferences and data, and an operating system for controlling internal functions and providing a user interface. Other embodiments of the device 100 include a cellular telephone, game consoles, control panels, musical devices, personal computers, or other computing devices with similar system components and function requiring a user input.

The stand-alone device 100 connects to the virtual keyboard 120 via a connector cable 110. The connector cable 110 is typically specific to the device 100. In one embodiment, the connector cable 110 is a serial connector. In a second embodiment, the connector cable 110 is a universal serial bus type cable (hereafter referred to as USB), Firewire (IEEE 1394), or a standard parallel port connector cable. The connector cable 110 interface may also lead from the virtual keyboard 120 to a “cradle” (not shown) that holds the device 100.

In another embodiment, the virtual keyboard 120 connected to the stand-alone device 100 by way of a wireless data link. One example of such a link is the “Bluetooth” protocol standard that can be found on the Internet at http://www.bluetooth.org.

As will be explained in detail below, the virtual keyboard 120 emits an electromagnetic wave from a line generator 123. As used herein, the term electromagnetic wave includes visible light waves, radio waves, microwaves, infrared radiation, ultraviolet rays, X-rays, and gamma rays. Although the following discussion relates mainly to emissions of light waves, it should be realized that any type of detectable electromagnetic wave energy could be emitted by the keyboard 120.

The line generator 123 emits a beam of light parallel to a surface 127, such as a desk. The beam of light preferably is generated as a plane of light that shines over a portion of the flat surface that is intended to act as a keyboard. Accordingly, a keyboard template 130 can be placed on the surface 127 in this position. Thus, the keyboard template 130 acts as a guide so the user knows where they place their fingers to activate a particular key.

The virtual keyboard also includes a detector 128 to detect the position of a user's fingers as they cross a plane of light 125 emitted by the line generator 123. By using the detector 128, the location of the reflection of the light beam 125 is calculated using image analysis software or hardware, as discussed below. For example, in one embodiment, the virtual keyboard 120 includes a look-up table to correlate the position of the reflected transmissions on the detector 128 with appropriate keystrokes based on the two dimensional position of the user's finger with respect to the template 130. The keystrokes are then sent to the device 100 as key data, such as a keyboard scan code.

Of course, the user would typically first set the position of the keyboard template 130 with respect to the position of the virtual keyboard 120. This can be accomplished by, for example, running a program within the virtual keyboard 120 that requests the user to touch particular keys in a specific sequence. The virtual keyboard then stores the coordinate positions of the requested keys to a memory and generates the relative coordinate positions of all of the other keys on the keyboard template.

The beam of light cast from the line generator 123 may or may not be visible to the user depending on the spectrum or frequencies emitted. Outputting the light beam results in the production of the detection plane 125 that runs parallel to and overlays the keyboard template 130. The template is used to indicate to the user the representative location of the keys. Of course, the keyboard template 130 is optional for a user to know where to place their fingers for a desired output of keystrokes and may not be required for expert users of the system.

In alternative embodiments, the virtual keyboard 120 may be imbedded directly within into a device 100. In such embodiments, the virtual keyboard 120 uses the hardware resources from the associated device, such as memory allocation space, processing power, and display capabilities. In another embodiment, the detector 128 is provided with inherent processing capabilities so that any image analysis software could be run using the integrated processing power of the detector. In yet another embodiment, only some of the processing power is shared between the detector and the associated device. Examples of alternative embodiments of an embedded virtual keyboard 120 are shown in FIGS. 10 to 16.

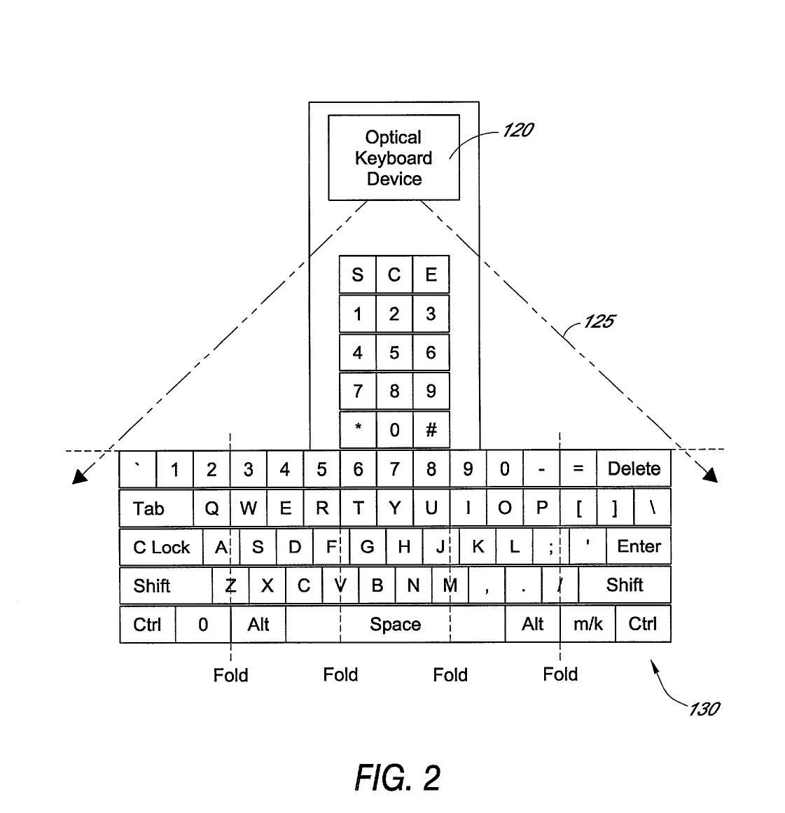

FIG. 2 shows an example of the keyboard template 130 with associated key positions. As indicated, the template is configured to represent identical key locations from a conventional QWERTY keyboard. However, the template 130 can be made from light-weight plastic, paper, or any other material that is easily transportable. As can be imagined, the template is designed to resemble a full size conventional keyboard, although it could be formatted to conform with any type of desired key placement. Once the locations of keys on the keyboard template 130 have been learned by the user, the template does not need to be provided and the user could enter data into an electronic device by typing keystrokes onto an empty desk. The positions of the user's fingers are still translated by the virtual keyboard into keystrokes and transmitted to the attached device.

When trying to measure reflections of light and sound off of a user's fingers, varying levels and types of detection can be implemented to provide other types of user inputs and keyboard templates. In one embodiment, a software module within the virtual keyboard 120 runs instructions which calculate reflected light sources with differing intensities and performs an image analysis to determine the location of the user's fingers by the light reflected from the user's fingers.

These results are then sent to the electronic output device 100 which lessens or eliminates the need for a keyboard template 130. Additionally, velocity measurements can be taken when multiple light sources are reflected back to the virtual keyboard 120. These measurements are used to determine if the user's break of the light beam was a ‘hit’ or just an accidental touch. In an additional embodiment, the virtual keyboard 120 is embedded into electronic devices such as computers, cellular telephones, and PDA's wherein the keyboard template is screen printed onto the device. Of course, the template could also be printed on paper for mobility purposes, or set under glass on a desk for a more stationary application.

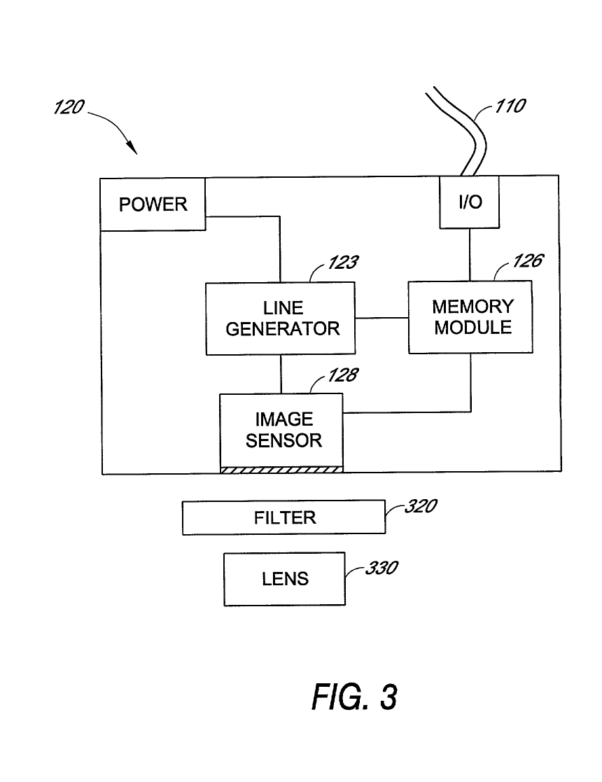

FIG. 3 is a block diagram that shows some of the basic components that are used to construct one embodiment of the virtual keyboard 120. The virtual keyboard 120 includes the detector 128, which can be a CCD or a CMOS image sensor. CMOS devices require less power then CCD image sensors, making them particular attractive for portable devices. CMOS chips can also contain a small amount of non-volatile memory to hold the date, time, system setup parameters, and constant data values, which also make the image analysis easier to perform. They can also contain custom logic which can be used in processing the data that is received from the detector. In one embodiment, the detector is a Photobit 0100 CMOS image sensor (Photobit Corporation, Pasadena, Calif.).

The virtual keyboard 120 can also include a filter 320 to exclude light or sound from the detector 128. The filter 320 is used to block out a majority of other frequencies or wavelengths, except the intended light emitted from the line generator 123. Moreover, the filter 320 increases the signal to noise ratio and lowers the power required from the light source. With the use of the filter 320 on the detector 128, most other frequencies of light are filtered out, increasing the sharpness of the returned image and decreasing the detector's 128 light sensitivity requirements and increasing the accuracy of the position calculations. In one embodiment, the filter is a Coherent Optics 42-5488 band pass filter (Coherent Optics, Santa Clara, Calif.).

Another component of the virtual keyboard 120 is a lens 330. The lens 330 is chosen to have a field of view that is complimentary to the size of the scanning area containing the light or sound plane. The lens 330 is also responsible for adjusting the focal point for clarity and reducing external contaminants from interfering with the image sensor 128. In one embodiment, the lens is a computer 3.6 mm ½ inch 1:1.6 C mount lens (Computar, Torrance, Calif.).

Another component of the keyboard 120 is the line generator 123 that generates one or more planes of light. In one embodiment, the line generator 123 produces a plane of light that is finite in width and runs parallel with the keyboard template and within the “field of view” of the lens 330. In one embodiment, the line generator is a laser line generator or light emitting diode (hereafter referred to as LED), although any form of light, including visible, infrared, microwave, ultraviolet etc, can be used. It should be realized that almost any electromagnetic energy source with a distinct pattern can be used, so long as it is detectable when a user's finger (or other object) reflects the generated signal back to the image detector 128 with the minimal amount of background noise or interference. In one embodiment, the laser line generator is a Coherent Optics 31-0615 line generator.

In an alternate embodiment, and as an added noise reducing/low power technique, the line generator can be pulsed (synchronized) with the hardware or software instructions that detect the reflected image. Because background measurements can be taken during time frames when the line generator is not active, the system can quickly determine the amount of background light present. With this information, the background light levels can be subtracted out of the measured images, providing a more accurate detection for objects that intersect the generated light plane.

One difficulty from background noise thus lies with light scattering off of background objects illuminated by the line generator. Pulsing the line generator can be synchronized so that it's only emitting light when the image sensor 128 is sensing the reflected light, and not when the image sensor 128 is no longer sensing the light (lowering the average output light intensity, along with power consumption).

It should be understood that the field of view of the lens 330 can be made up of many factors, including the focal point of the lens 330 located on the virtual keyboard 120, the distance of the image sensor 128 from the objects, or even the software instructions that first determine the location on the image plane of the reflected light off of the user's finger (or other object). This is done by running image processing instructions on the image captured by the image sensor 128.

Instructions stored in a memory module 127 within the virtual keyboard receive one or more signals from detector 128 corresponding to the real-time positions of any objects that interrupt the detection plane 125. In one embodiment, the image processing instructions use a derivative of the signal intensity, Fourier analysis of the array, or threshold detection to determine the coordinate position of the user's finger in relationship to the virtual keyboard 120. The instructions then correlates the position of the user's finger with a letter, number, or other symbol or command. That letter, number, symbol, or command is then sent to the device 100 through the cable 110 (FIG. 1). Of course, it should be realized that this is but one embodiment of the invention. For example, the instructions software or hardware instructions, and thus could be stored in a conventional RAM or ROM memory of the device 120, or programmed into an ASIC, PAL or other programmable memory device.

As described above, a camera, CCD, CMOS image sensor, or other image detection device is used to detect light along the detection plane 125. The image sensor 128 can also include the filter 320 if the corresponding wavelength of light is emitted by the line generator 123. The filter 320 is designed to block out most wavelengths of light other than the wavelength being emitted by the line generator 123. This increases the accuracy of the image, through the lens 330, onto the image sensor 310 by lessening background noise from entering the detector 128.

The detector 128 is preferably positioned so that the reflected light from each possible position of the user's fingers has a unique position on the image detector's field of view. The detector 128 then sends captured images/signals to a set of instructions to perform an image analysis on the captured signal. The signal is preferably analyzed using a threshold detection scheme which allows only reflected light with an intensity over a certain level to be analyzed. The correlating position is then compared with the predetermined template for positions of the symbol (letter, number or command). A signal then is sent back to the device 100 to indicate the detected symbol.

It should be realized that inputs to the system are not limited to keystrokes. Any movement that can be detected by the detector is within the scope of the invention. For example, one portion of the keyboard template 130 could be a slider region that resembled a conventional slider control found within personal computer software for adjusting, for example, the volume of the computer's speakers. Accordingly, a user could change the volume of the attached electronic device by moving their finger up or down within the slider region of the keyboard template.

In one embodiment, the line generator, image sensor, filter and lens are positioned at approximately 12″ away from the keyboard template 130. The distance from the line generator 123 and the virtual keyboard 120 system will vary depending on the lens 330 used. This provides some flexibility, but has tradeoffs between size and resolution of the image sensor 310.

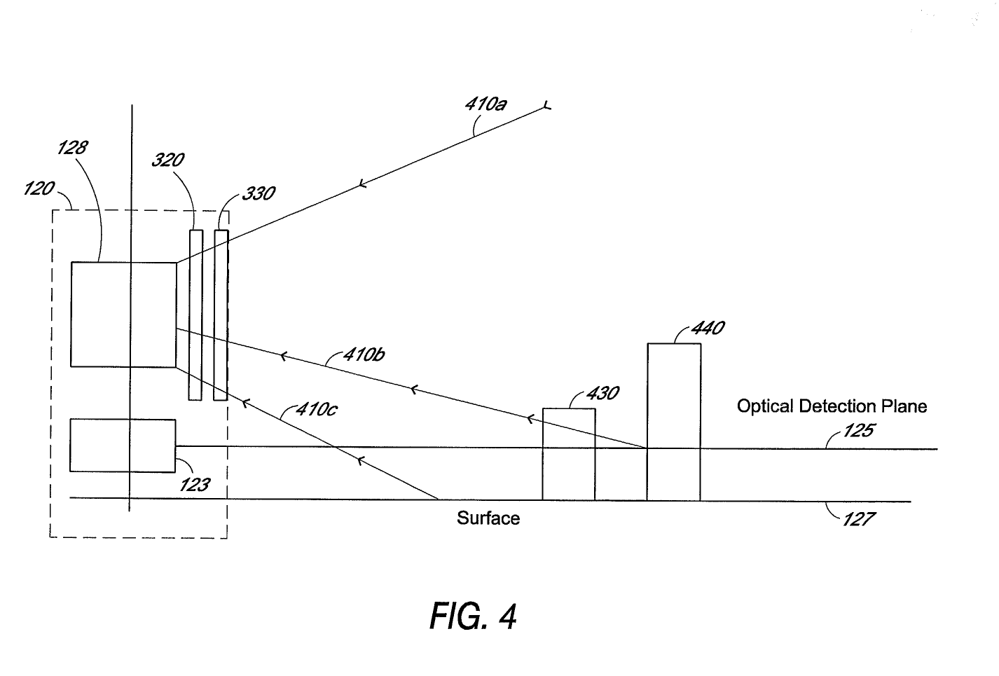

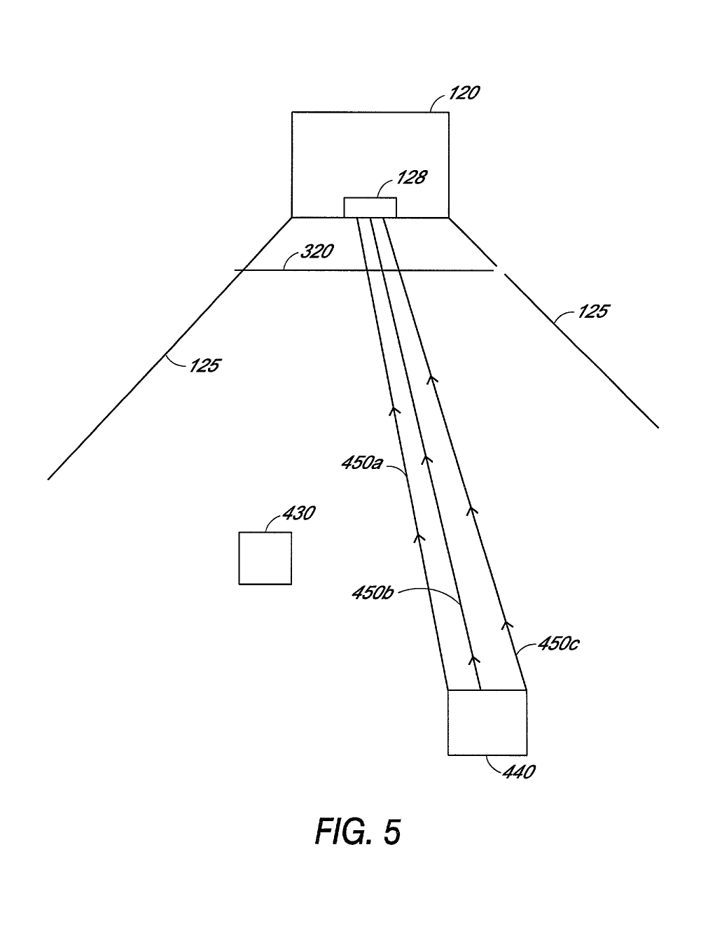

FIGS. 4, 5, and 6 are line drawings showing the emission of light energy across a flat surface. When the virtual keyboard 120 is in operation, the line generator 123 emits the plane 125 of light or sound over the surface 127. Of course, the surface 127 preferably includes a keyboard template that provides the user with guidance as to where they should strike the surface 127 in order to activate a particular key. A user always has the option of using a template keyboard 130 as a quick reference for where each key located. In actuality, the template plays merely a visual role to aid the user.

In one embodiment, the keyboard 130 emits a coordinate matrix of energy that is sent along single, or multiple, detection planes 125. When the user's finger penetrates the detection plane, the light or sound reflects back into the image sensor 128, through the lens 330 and filter 320, wherein the coordinate information is gathered.

FIG. 4 shows a side view of the virtual keyboard 120 including the image sensor 128, the line generator 123, the lens 330, and the filter 320. As illustrated, the optical detection plane 125 generated by the line generator 123 intersects with a first object 430 and a second object 440. The size of the detection plane 125 is determined by a mathematical formula that relates to the resolution, size, light source(s) and optics used with the detector 128. As can be imagined, the further away an object is from the detector 128, the lower the resolution the object will transmit to the detector 128. Accordingly, the device 120 has a limited field of view for detecting objects, and objects that are closer will be detected with greater accuracy.

As shown in FIG. 4, a series of vectors 410A-C illustrate the range of object detection provided by the virtual keyboard 120. The image sensor 310 obtains an image of, for example, object 430, and then instructions are run to identify the height of the object 430, as well as its width and location within a coordinate matrix. The vectors 410A-C show the “field of view” for the detector 128.

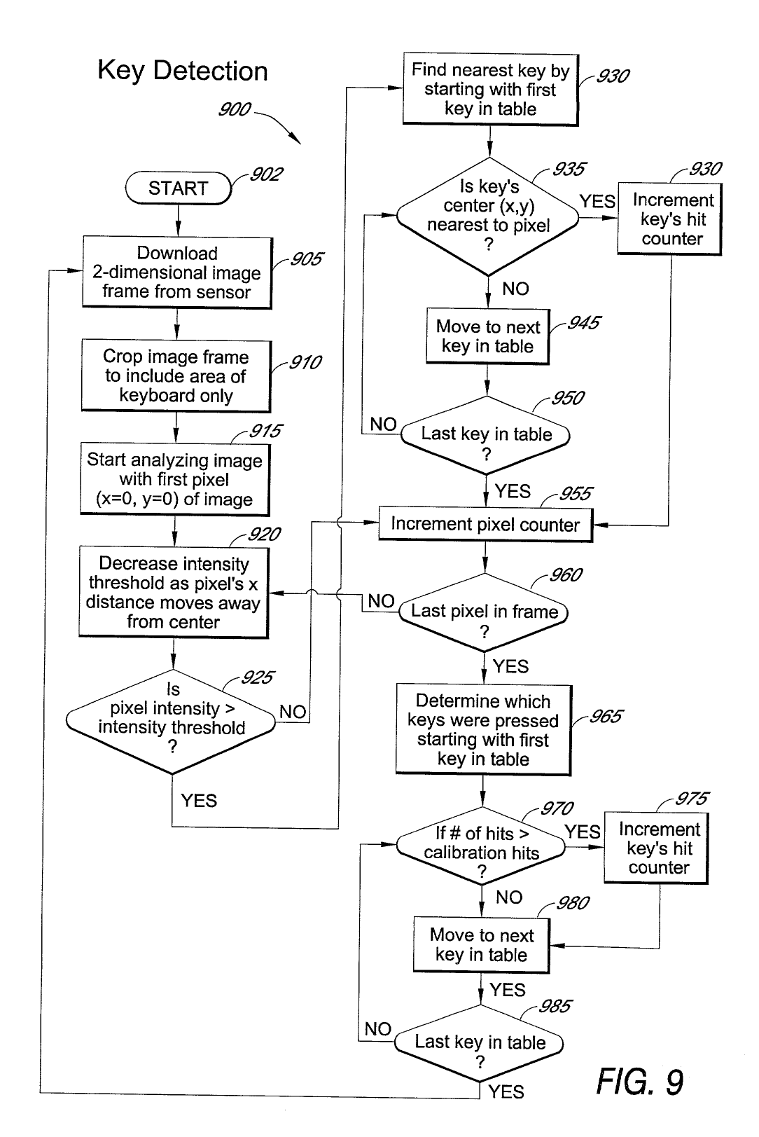

In one embodiment, the field of view is adjustable to better suit the needs of the user. The detection plane 125 that is created by the line generator 123 may not be visible to the human eye, depending on the wavelength and type of electromagnetic energy output. As shown, it is apparent that the first object 430 and the second object 440 have broken the detection plane 125. The coordinate matrix that is created by the detector 128 will attempt to provide the coordinates of the location where the detection plane 125 has been broken. One method of analyzing the reflected light from the objects 430 and 440 and determining their position on the coordinate matrix is illustrated below with reference to FIG. 9.

Referring to FIG. 5, a top view of the virtual keyboard 120 emitting a beam from the line generator 123 and also showing the detection of the object 440 is illustrated. The vectors 450A-C are reflecting off of the object 440 and returning back to the image sensor 128. The returned image is then analyzed to determine the outer edges of the object 440 in an attempt to assign a relationship to a coordinate matrix created in the optical detection plane 125. Note that in the side view of FIG. 4 it may appear that the first object 430 and the second object 440 are in the same plane. However, the top view of FIG. 5 clearly shows that the objects break the detection plane 125 in two distinct coordinate positions.

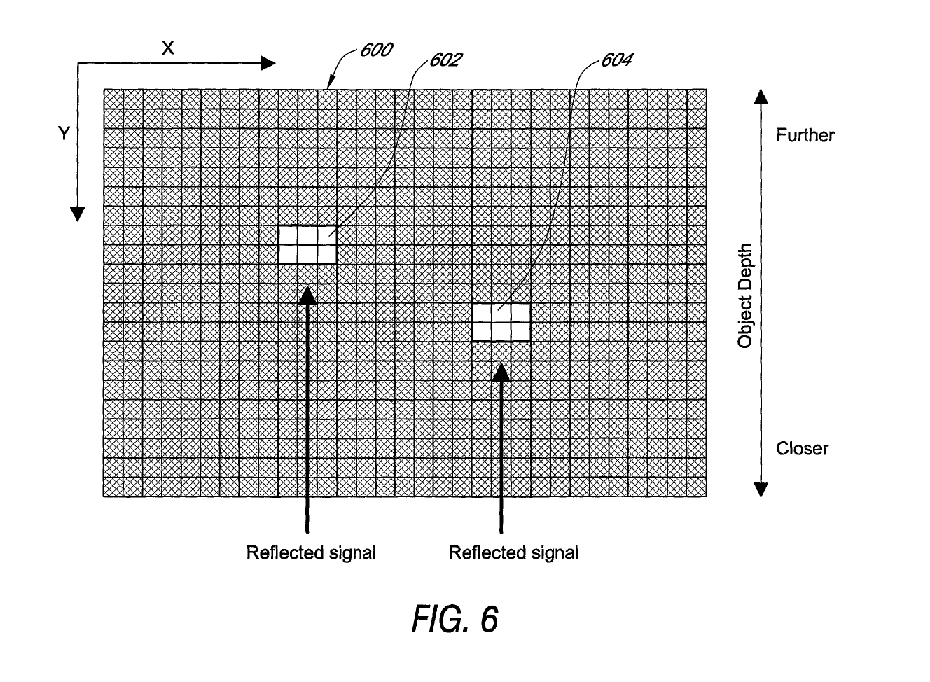

FIG. 6 is an illustration that shows the corresponding image matrix 600 that appears on the image sensor 128 from the reflected images of the objects 430 and 440 in the detection plane 125. This figure illustrates the reflected images from the detection plane 125. The illuminated regions 602 and 604 correspond to the first object 430 and second object 440, respectively breaking the detection plane 125. The image instructions stored within the virtual keyboard 120 read the image from the image sensor 128 and determine the position of the first object 430 and the second object 440 in the detection plane 125. The position of the object is then compared to a stored table of positions, and the symbol associated with that position or movement is determined and transmitted to the device 100 as the appropriate keystroke.

As discussed above, in one embodiment, the line generator 123 generates a laser line parallel to the table. Thus, when the first object 430 or second object 440 reflects the transmitted light, a resultant two-dimensional matrix image created on the detector 128 is analyzed by instructions performing one or more of the following functions:

1. Threshold detection or edge detection (detect changes in signal intensity)

2. Coordinate translation based on multiple points from reflected optical signal. This can be calibrated, or computed mathematically using basic optics and trigonometry. The analysis takes into account the effect of the varying distance and angle of the detector 128 to the object.

3. The output of the coordinate translation can then be used to determine location of mouse, key pressed, or position.

4.

Any detected images that fall outside the field of view of the detector, or are screened out by the filter 320, are automatically removed before the signal from the detector is analyzed.

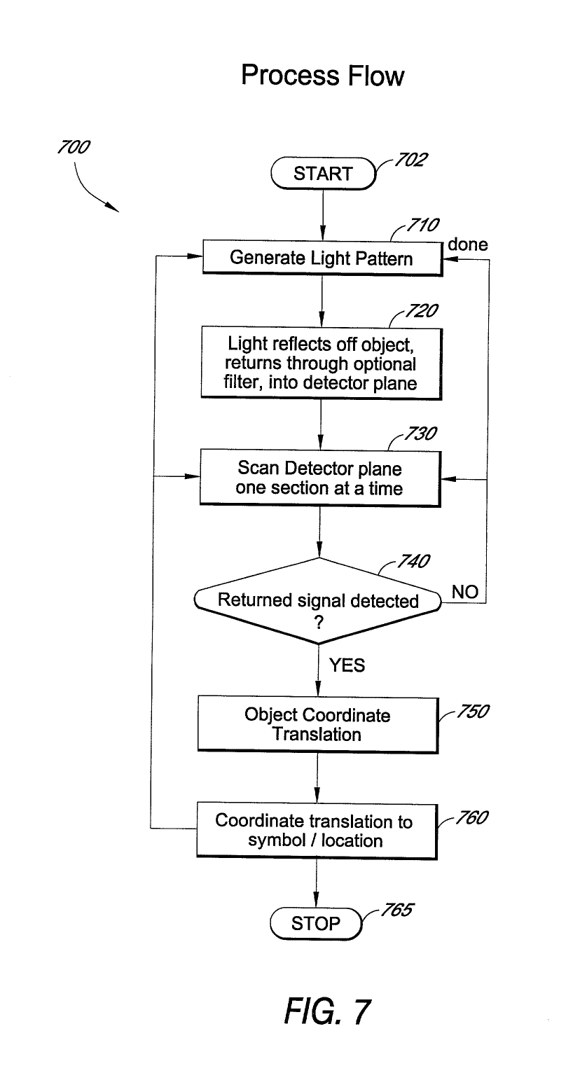

FIG. 7 is a flow chart showing one embodiment of a method 700 for detecting an object within the field of view of the keyboard 120, and thereafter analyzing the detected object position to accurately determine the correct a keystroke by the user. The process flow begins after the device 100 is connected to the reconfigurable virtual keyboard 120 via the connection cable 110, or when an embedded keyboard within an electronic device is turned on.

The method 700 begins at a start state 702 and then moves to a state 710 wherein a light pattern is generated by the line generator 123. The beam of light or sound is emitted in order to produce the detection plane 125. In addition, the keyboard being used is identified to the virtual keyboard 120 so that each position on the coordinate matrix will correspond to a predetermined keystroke.

The process 700 then moves to a state 720 wherein light is reflected off of an object, such as the user's finger, such that the emitted light is sent back through the filter 320 and into the detector 128. The process 700 then moves to a state 730 wherein instructions within the virtual keyboard 120 scan the image input from the detector 128. In one method, the image is scanned by individually determining the intensity of each pixel in the detected image. Pixels that differ in intensity over the background by a predetermined amount are then further interrogated to determine if they correspond to the size and location of a user's finger.

Once the scanning process has begun at the state 730, the process 700 moves to a decision state 740 wherein a determination is made whether a return signal indicating a keystroke has been found. If a return signal is not detected at the decision state 740, the process 700 returns to state 710 to continue scanning for other objects.

However, if a signal is detected in the decision state 740 the process 700 continues to a state 750 wherein an object coordinate translation process is undertaken by instructions within a memory of the virtual keyboard 120. At this state, the instructions attempt to determine the coordinate position of the keystroke within the detected field. This process is explained more specifically with reference to FIG. 9 below.

Once the coordinate position of the keystroke is determined, the process 700 moves to a state 760 wherein the coordinate position of the user's finger is matched against a keystroke location table. The intended keystroke is then determined and the results are output to the electronic device 100. Finally, the process 700 terminates at an end state 765. The process continues until the device 100 communicates to the virtual keyboard 120 to stop taking measurements or is shut off.

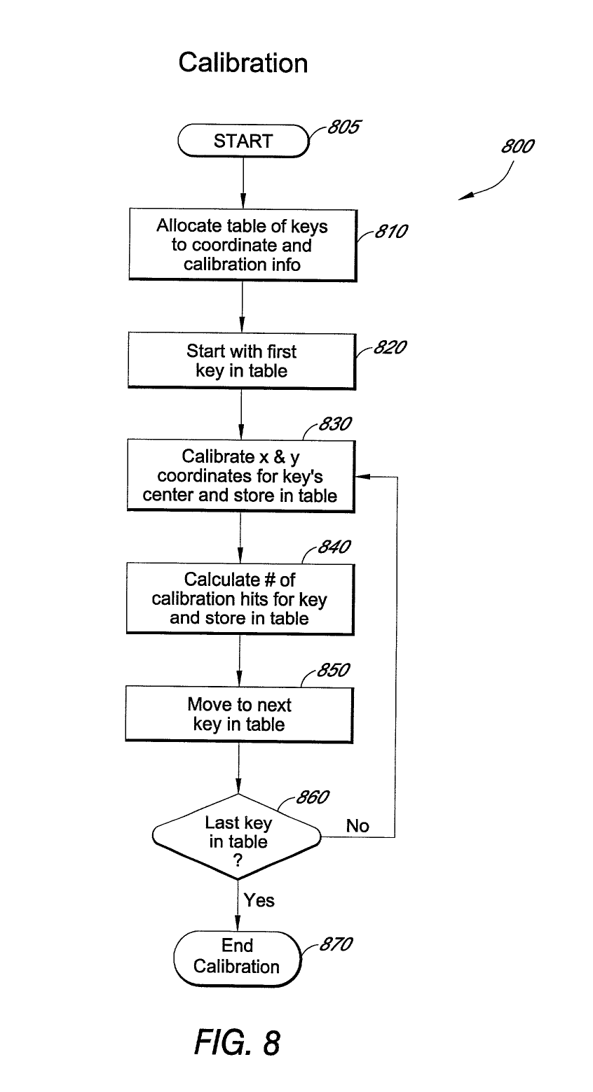

One embodiment of a process 800 for calibrating a virtual keyboard is shown in FIG. 8. This process may be implemented in software on a personal computer using a C++ programming environment, or any other relevant programming language. The instructions that carry out the process algorithm are then stored within a memory in the virtual keyboard 120, or a device communicating with the virtual keyboard 120.

The calibration process 800 is used to calibrate the varying intensities of light that are detected for each key position on the template. For example, it should be realized that the intensity of the reflected light diminishes as the user's fingers are detected progressively further away from the line generator and detector. Accordingly, the system compensates for the diminished intensity by selecting varying cut-off values for detecting a keystroke depending on the distance of the detected object from the line generator.

The system is preferably calibrated so that the keyboard template is always placed at a fixed location with respect to the virtual keyboard 120. However, it should be realized that the system could auto-calibrate so that a user would position the keyboard template at a location to their liking (within the field of view of the detection system) and the user would then indicate the template's position to the virtual keyboard 120. A fixed template position has benefits in that it would have a standard translation coordinate mapping from the detector coordinate locations to the keystroke coordinate locations. In addition, the electronics and software overhead to support a fixed position template are lower than with a template that could be positioned in various places with respect to the virtual keyboard.

The process 800 begins at a start state 805 and then moves to a state 810 wherein a master table of keys to the coordinate and calibration information is allocated. The master table of keys holds the coordinate position of each key and the associated calibration information for that key. As discussed above, the calibration information relates to the threshold of reflected light that is required at a particular coordinate for the system to interpreted a reflection as a key press. The process 800 then moves to a state 820 wherein the first key in the table to be calibrated is chosen. After this key is chosen, the process 800 moves to a state 830 wherein the x and y coordinates of the assigned keys “center” are stored in the table. The x and y coordinates for this key can be determined, for example, by requesting the user to press the proper place on the keyboard template that corresponds with the determined key. The location of the detected position on the detector 128 is then used as the x and y coordinates of the key.

Once the first key has been determined at the state 830, the process 800 moves to a state 840 wherein the number of calibration hits for the specific key are calculated and stored in a keyboard table within the virtual keyboard 120.

If an 8-bit image sensor is used as a detector, the pixel values for the sensor range from 0 to 255. During calibration, as the user strikes each key, an intensity value is recorded. The number of pixels that are illuminated above the predefined intensity threshold during this key strike is stored in the table as “calibration hits.” In addition, the center of each key is determined and stored as an (x,y) value during the key strike.

In state 850, the process moves to the next key in the table. At state 860, the system determines if the current key is the last key located in the table. If the current key is not the last key, then the process returns to state 830 to record the necessary information for the current key. When the process reaches the last key in the table then the process moves to state 870 where the calibration process ends.

In one embodiment a user defines a keyboard template 130 and assigns the location of keys to a virtual keyboard created in the optical detection plane 125. The user then calibrates the detection plane 125 prior to use so that the system will efficiently interpret the user's keystrokes or other breaks in the detection plane 125. Accordingly, when a key on the template is touched, the light generated from the line generator 123 reflects off of the user's finger resulting in illuminated pixels on the detector 128.

FIG. 9 shows one embodiment of a process 900 for detecting whether a user has attempted to activate a key on the virtual keyboard. It should be realized that in one embodiment, the ideal frame rate per second of capturing images with the detector along of the virtual keyboard should be approximately 20-30 frames/second based on ideal typing speeds. Of course, the invention is not limited to any particular sampling rate, and rates that are higher or lower are within the scope of the invention.

As discussed above, the captured image frame is a two-dimensional (x,y) array of pixels. As each image is captured, it is analyzed on a pixel by pixel basis. If the pixel intensity exceeds an intensity threshold, its nearest key is found and that key's “hit counter” is incremented. After the entire frame is analyzed, the key is detected to be pressed if the final value of the hit counter exceeds the number of calibration hits. If the key is detected to be pressed, it is sent to the device 100. The device 100 then has the option of displaying the results, recording the results in a data format, or making an audible sound when there is movement in the detection plane 125.

As shown in FIG. 9, the process 900 for detecting keystrokes is exemplified. The process begins at a start state 902 and then moves to a state 905 wherein a two-dimensional image frame is downloaded from the detector 128. At state 910, the image is cropped to only contain information within the pre-defined field of view. In state 915 the image is analyzed starting with the first pixel (x=0, y=0). In state 920 the requirements for the intensity of the image pixel to activate a key decreases as it moves away from the center. In decision state 925 the system determines if the pixel intensity is greater than the intensity threshold for the location of the object on the detector. If the pixel intensity is not greater, the process moves to state 955. However, if the pixel intensity is greater, the process moves to state 930 wherein the key that has a coordinate location at the position of the detected pixel is identified, starting with the keys recorded in the master table.

The process seeks to identify which key the illuminated pixel in the image sensor 128 is nearest in state 935. If the illuminated pixel is near a specific key, that key's hit counter is incremented by one in state 940 and the process jumps to state 955 where the pixel counter is incremented. The process 900 the moves to state 945 wherein the process moves to the next key in the master table.

The process 900 then moves to a decision state 950 to determine if the current key is the last key in the table. If the answer is no, the process 900 returns to state 935 where a new key is tested until a match is found. If a key is found and the process has checked the last key in the table, the process moves to state 955 wherein the pixel counter is incremented.

The process 900 then moves to decision state 960 to determine if the current pixel is the last in the frame. If it is not, the process returns to state 920 wherein the pixel intensity is decreased. If the current pixel is the last pixel, then the process moves to step 965 where the determination is made as to which keys were pressed by the user. The process 900 then moves to decision state 970 to determine if the number of hits is greater than the number of calibration hits. If the number of hits is greater, then the process 900 moves to state 975 where the key command associated with the activated key is output to the device 100. However, if the number of hits is not greater, the process 900 moves to the next key in the table in state 980. At the decision state 985, the process 900 determines if the current key is the last key in the table in state 985. If not, then the process 900 returns to state 905 wherein the process starts again.

In one embodiment this invention consists of a stand-alone device 100 that is capable of supporting a user interface and displaying an output from a secondary source. This stand-alone device 100 can then be connected to a reconfigurable virtual keyboard 120 via any number of cable or wireless connections 110 determined by cost and efficiency. The virtual keyboard 120 may consist of an image sensor 310, environmental filter 320, lens 330, and a line generator 123. The line generator 123 will cast a detection plane 125 of light or sound over a surface creating an “invisible” keyboard 130. The detection plane 125 may have a user configured keyboard template 130 place underneath for reference. When an object breaks the detection plane 125 a reflection is measured through the optical detector 128, and more specifically through: a lens 330, a filter 320, and into the image sensor 310 for processing in the image analysis device 115. The algorithms are applied to detect the locations of each break in the detection plane 125 and keystrokes are assigned to the output device 100.

Other Embodiments

Although one embodiment of a stand alone electronic input device has been described above, the invention is not limited to such a device. For example, in another embodiment, an embedded virtual keyboard is mounted to into a wireless telephone. In this embodiment the detector and the light generator are embedded into the wireless telephone. The line generator would be mounted in such a position so that the telephone would stand on a flat surface, and a detection plane would be generated over the flat surface. A template could then be placed on the flat surface, and a user's fingers touching the template would be detected by the integrated detector, and the keystrokes thereby entered into the wireless telephone.

Another embodiment is a virtual keyboard that is embedded into a personal digital assistant (PDA). Similar to the wireless telephone described above, the PDA would include a detector and line generator for creating a detection plane, and detecting keystrokes within the detector plane.

Still another embodiment of a virtual keyboard is a laptop computing device that includes an embedded line generator and detector. In place of the standard laptop keyboard could be a flat plastic template showing key positions. With this current embodiment, the laptop becomes more rugged and less susceptible to liquids and humidity since the keyboard is printed on the computer as a washable template.

Another embodiment of the invention is an embedded virtual keyboard that is mounted into a game board, such as for checkers, chess or other games. Any game board could utilize the technology to either detect a game piece position or a finger to indicate movement or game input. As an example, chess could be played using traditional game pieces with the detector 128 properly calibrated for the board. The calibration for each game is purchased or downloaded over the Internet.

Yet another embodiment is a virtual keyboard that is embedded into a musical device. Due to the flexibility of the virtual keyboard, any design or style of musical keyboard could be printed out in a template format and used with the instrument. As an example, a piano keyboard could be printed out on a plastic surface. The virtual keyboard would then detect the position of a musician's fingers, which would result in output music corresponding to the keys played by the musician. The musician could then have an extremely portable instrument. Designers of musical devices could now design their own keyboard layout and utilize designs that differ from the standard piano keyboard layout.

Another embodiment is a virtual keyboard 120 that is attached to a computer monitor to make it a touch screen device. The device could either be embedded in the monitor or added after the fact so that using a software program the user could make their monitor touch screen enabled allowing for the keyboard template or other control requests to be displayed on the computer monitor.

Another embodiment of the invention is a reconfigurable control panel for a machine. A manufacturer of a machine requiring a control panel could print out the control panel and use the invention to detect the input from the user. Any upgrades could easily be made by just printing out a new control panel template. The control panel could be printed on any suitable material that will meet the environmental or user interface needs of the machine.

What is claimed is:

1. A reconfigurable keyboard, comprising:
a stored keyboard map comprising key locations;
an electromagnetic wave output that generates an electromagnetic signal;
a detector for detecting an object contacting the electromagnetic signal;
instructions for calculating the coordinates of the object and determining which key location has been activated.

2. The reconfigurable keyboard of claim 1, wherein the stored keyboard map comprises a map of a personal computer 101 key keyboard.

3. The reconfigurable keyboard of claim 1, wherein the electromagnetic wave output comprises a laser or a light emitting diode.

4. The reconfigurable keyboard of claim 1, where in the electromagnetic wave output comprises a line generator.

5. The reconfigurable keyboard of claim 1, where in the electromagnetic wave output generates sound waves.

6. The reconfigurable keyboard of claim 5, where in detector comprises an acoustic detector.

7. The reconfigurable keyboard of claim 1, wherein the detector comprises a charge-coupled device (CCD) or a CMOS image sensor.

8. The reconfigurable keyboard of claim 1, comprising a filter that prevents particular wavelengths of light from entering the detector.

9. The reconfigurable keyboard of claim 1, wherein the instructions are configured to perform edge detection or threshold detection to determine which key location has been activated.

10. The reconfigurable keyboard of claim 1, wherein the instructions are configured to perform coordinate translation to determine which key location has been activated.

11. The reconfigurable keyboard of claim 1, comprising instructions that output conventional computer keyboard commands corresponding to the key location that is activated.

12. An electronic keyboard, comprising:
a stored keyboard map comprising key locations;
a line generator that outputs an electromagnetic wave across a plane;
a detector for detecting objects that traverse the plane;
stored instructions for determining the position of an object and calculating which key location within said keyboard map has been activated.

13. The electronic keyboard of claim 12, wherein the stored keyboard map comprises a map of a personal computer 101 key keyboard.

14. The electronic keyboard of claim 12, wherein the detector comprises a charge-coupled device (CCD) or a CMOS image sensor.

15. The electronic keyboard of claim 12, comprising a filter that prevents particular wavelengths of light from entering the detector.

16. The electronic keyboard of claim 12, wherein the instructions perform edge detection or threshold detection to determine which key location has been activated.

17. The reconfigurable keyboard of claim 12, where in the electromagnetic wave output generates sound waves.

18. The reconfigurable keyboard of claim 17, wherein the detector comprises an acoustic detector.

19. The reconfigurable keyboard of claim 12, where in the electromagnetic wave output generates infrared light.

20. The electronic keyboard of claim 12, wherein the instructions perform coordinate translation to determine which key location has been activated.

21. The electronic keyboard of claim 12, wherein the key locations comprise coordinates of a mouse region, and wherein the instructions comprise instructions for moving a mouse pointer on a display.

22. The electronic keyboard of claim 12, wherein the key locations comprise coordinates of a slider region, and wherein the instructions comprise instructions for adjusting the position of a slider control on a display.

23. A method of transmitting data to an electronic device, comprising:
generating a light plane parallel to a surface;
detecting the position of an object that traverses the light plane
determining the position of an object breaking the light plan;
mapping the coordinate position of the object to a stored keyboard map comprising key locations;
determining which key location within said keyboard map was activated;
transmitting a code corresponding to the activated key to an electronic device.

24. The method of claim 23, wherein the surface comprises a layout of a keyboard.

25. The method of claim 23, wherein the light plane is a laser light plane generated by a line generator.

26. The method of claim 23, wherein the position of the object is detected with a charge-coupled device (CCD) or an CMOS image sensor.

27. The method of claim 23, wherein the code transmitted to the electronic device is a conventional personal keyboard code.

28. The method of claim 23, wherein the electronic device is selected from the group consisting of: a personal computer, Internet appliances, a personal digital assistant and a wireless telephone.

29. A reconfigurable keyboard, comprising:;
a light output that generates a light plane;
a detector for detecting an object traversing the light plane;
instructions for calculating the position of the object.

30. The reconfigurable keyboard of claim 29, comprising a stored keyboard map.

31. The reconfigurable keyboard of claim 29, wherein the instructions calculate a change in the position of the object.

32. The reconfigurable keyboard of claim 29, wherein the light output comprises a line generator.

33. The reconfigurable keyboard of claim 29, where in the light output generates infrared light.

34. The reconfigurable keyboard of claim 29, where in the light output is pulsed or modulated.

35. The reconfigurable keyboard of claim 30, where in the detector is a CMOS image sensor.

36. The reconfigurable keyboard of claim 30, where in the detector is a CCD image sensor.

37. A method of transmitting data to an electronic device, comprising:
generating a light plane parallel to a surface;
detecting the position of an object that traverses the light plane
determining the position of an object breaking the light plan;
mapping the coordinate position and movement of the object.

38. The method of claim 37, wherein the surface comprises a keyboard template.

39. The method of claim 37, wherein the surface comprises mouse template.
